(19) United States
(12) Patent Application Publication
(10) Pub. No.: US 2007/0122674 A1
(43) Pub. Date: May 31, 2007

(54) Solid oxide fuell cell and method for manufacturing the same

(75) Inventors: Michio Horiuchi, Nagano (JP); Yasue Tokutake, Nagano (JP); Shigeaki Suganuma, Nagano (JP); Jun Yoshiike, Nagano (JP); Fumimasa Katagiri, Nagano (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD.

(21) Appl. No.: 11/604,848

(22) Filed: Nov. 28, 2006

(30) Foreign Application Priority Data
Nov. 29, 2005 (JP) P. 2005-344190

(51) Int. Cl. H01M 8/12; C04B 35/64; H01M 8/24

(52) U.S. Cl. 429/32; 429/44; 264/618

(57) ABSTRACT

A solid oxide fuel cell C2 has a laminate including a solid electrolyte substrate, a cathode electrode layer 2 formed on one side of the substrate and an anode electrode layer formed on the other side of the substrate. A metallic mesh M is formed all over the solid electrolyte substrate on one or both of the cathode electrode side and the anode electrode side. The laminate includes a plurality of small fuel cell divisions C2n which are electrically connected to each other with the metallic mesh. The laminate having an electrolyte sheet of green sheet, a cathode electrode paste layer, an anode electrode paste layer and a metallic mesh laminated on each other is sintered to undergo cracking, thereby forming a plurality of small fuel cell portions.

### BACKGROUND OF THE INVENTION

The present invention relates to a solid oxide fuel cell and more particularly to a solid oxide fuel cell which can be produced by a method which includes forming one fuel cell unit in the form of a plurality of partial laminate divisions during the firing of a laminate of an electrolyte substrate, a cathode electrode layer an anode electrode layer and electrically connecting the partial laminate divisions to each other with an electrically-conductive material layer to provide a simple structure requiring no enclosure, thereby attaining both cost reduction and enhancement of impact resistance.

The volume density of the electrolyte becomes equal to or less than 70% by firing and becomes equal to or more than 90% by sintering.

A solid oxide fuel cell of the type including a solid electrolyte is heretofore developed. An example of the fuel cell including a solid electrolyte is one including as an oxygen-ionically conductive solid electrolyte substrate a fired material made of stabilized zirconia having yttria (Y₂O₃) incorporated therein. A cathode electrode layer is formed on one side of the solid electrolyte substrate while an anode electrode layer is formed on the other side of the solid electrolyte substrate. Oxygen or an oxygen-containing gas is supplied into the fuel cell on the cathode electrode layer side thereof while a fuel gas such as methane is supplied into the fuel cell on the anode electrode layer side thereof.

In this fuel cell, oxygen (O₂) which is supplied into the cathode electrode layer is ionized to oxygen ion (O²⁻) at the interface of the cathode electrode layer with the solid electrolyte substrate. The oxygen ion is conducted through the solid electrolyte substrate to the anode electrode layer where it then reacts with the gas such as methane (CH₄) which is supplied thereinto to produce water (H₂O), carbon dioxide (CO₂), hydrogen (H₂) and carbon monoxide (CO). In this reaction, oxygen ion releases electron to make some difference in potential between the cathode electrode layer and the anode electrode layer. Accordingly, a lead wire can be attached to the cathode electrode layer and the anode electrode layer so that electron in the anode electrode layer flows through the lead wire toward the cathode electrode layer to generate electricity as a fuel cell. The driving temperature of the fuel cell is about 1,000° C.

However, this type of a fuel cell requires that separate chambers be provided, that is, an oxygen or oxygen-containing gas supplying chamber be provided at the cathode electrode layer side thereof and a fuel gas supplying chamber be provided at the anode electrode layer side thereof. Further, since this type of a fuel cell is exposed to an oxidizing atmosphere and a reducing atmosphere at high temperatures, it is difficult to enhance the durability as fuel cell unit.

On the other hand, a fuel cell is developed which includes a cathode electrode layer and an anode electrode layer provided on the opposing sides of two sheets of solid electrolyte substrate, respectively, to form a fuel cell unit that is adapted to be disposed in a fuel gas such as mixture of methane gas and oxygen gas to cause the generation of electromotive force between the cathode electrode layer and the anode electrode layer. The principle of this type of a fuel cell in the generation of electromotive force between the cathode electrode layer and the anode electrode layer is the same as that of the aforementioned separate chamber type fuel cell. However, since the aforementioned proposal is advantageous in that the fuel cell unit can be entirely disposed in substantially the same atmosphere, it can be in the form of a single chamber which can be supplied with a mixed fuel gas, making it possible to enhance the durability of the fuel cell unit.

However, this single chamber type fuel cell, too, must be driven at a temperature as high as about 1,000° C. and thus is subject to the risk of explosion of mixed fuel gas. When the oxygen concentration is lowered under the flammability limit to avoid this risk, the carbonation of the fuel such as methane proceeds, raising a problem of deterioration of cell performance. In order to solve this problem, a single chamber type fuel cell is proposed which can employ a mixed fuel gas in an oxygen concentration allowing prevention of explosion of mixed fuel gas as well as prevention of progress of carbonation of fuel.

The above proposed single chamber type fuel cell includes fuel cell units containing a solid electrolyte substrate laminated on each other parallel to the flow of the mixed fuel gas. The fuel cell unit has a solid electrolyte substrate having a dense structure and a porous cathode electrode layer and a porous anode electrode layer formed on the respective side of the solid electrolyte substrate. A plurality of fuel cell units having the same configuration are laminated in a vessel made of ceramic. These fuel cell units are hermetically sealed in the vessel by an end plate with a filler provided interposed therebetween.

The vessel is provided with a feed pipe for mixed fuel gas containing a fuel such as methane and oxygen and a discharge pipe for exhaust gas. The vessel is filled with a filler in the space excluding the fuel cell unit and allowing the flow of the mixed fuel gas and the discharge gas in such an arrangement that a proper gap is formed. In this arrangement, when this system is driven as a fuel cell, ignition cannot occur even when a mixed fuel gas within the flammability range exists.

A fuel cell having another configuration is developed. The basic configuration of this fuel cell is the same as that of the aforementioned single chamber type fuel cell. However, this fuel cell includes fuel cell units containing a solid electrolyte substrate laminated along the axis of the vessel perpendicular to the flow of the mixed fuel gas. In this case, the fuel cell unit includes a porous solid electrolyte substrate and a porous cathode electrode layer and an anode electrode layer formed on the respective side of the solid electrolyte substrate. A plurality of fuel cell units having the same configuration are laminated in a vessel.

The aforementioned fuel cell includes fuel cell units received in a chamber. On the other hand, a solid oxide fuel cell device is proposed which is adapted to be disposed in or in the vicinity of flame so that the heat of flame causes the solid oxide fuel cell to be kept at its operating temperature to generate electricity. An embodiment of this solid oxide fuel cell is a solid oxide fuel cell including an anode electrode layer formed on the outer surface of a tubular solid electrolyte substrate. This type of a solid oxide fuel cell is mainly disadvantageous in that radical components from flame cannot be supplied into the upper half of the anode electrode layer, disabling the effective use of the entire surface of the anode electrode layer formed on the outer surface of the tubular solid electrolyte substrate. Thus, this type of a solid oxide fuel cell exhibits a low electricity generation efficiency. Further, since this type of a solid oxide fuel cell is unevenly heated directly by flame, it is disadvantageous in that sudden temperature change can easily cause cracking.

In order to solve these problems, an electricity generating device including a solid oxide fuel cell is proposed as a simple electricity supplying unit which employs a solid oxide fuel cell of the type allows direct utilization of flame produced by the combustion of a fuel in such a manner that the entire surface of an anode electrode layer formed on a flat solid oxide substrate is exposed to flame, thereby enhancing the durability and electricity generation efficiency and reducing the size and cost (for example, refer to Patent Reference 1).

An electricity generation device including the above proposed solid oxide fuel cell is shown in FIG. 14. A solid oxide fuel cell C utilized in the electricity generation device shown in FIG. 14 includes a flat circular or rectangular solid electrolyte substrate 1, a cathode electrode layer 2 formed as an air electrode (oxygen electrode) formed on one side of the substrate 1 and an anode electrode layer 3 formed as a fuel electrode on the one and the other sides of the substrate 1. The cathode electrode layer 2 and the anode electrode layer 3 are disposed opposed to each other with the solid electrolyte substrate 1 provided interposed therebetween.

The solid oxide fuel cell C thus configured is used as an electricity generation device which is adapted to be exposed to flame f produced by the combustion of a fuel gas while being supported over a gas burner 4 into which a fuel gas is supplied with the anode electrode layer 3 of the fuel cell C facing downward. A fuel which is combusted to produce flame causing oxidation is supplied into the gas burner 4. As the fuel there may be used phosphorus, sulfur, fluorine, chlorine or a compound thereof. An organic material which requires no discharge gas treatment is preferred. Examples of the organic fuel employable herein include gases such as methane, ethane, propane and butane, gasoline-based liquids such as hexane, heptane and octane, alcohols such as methanol, ethanol and propanol, ketones such as acetone, other organic solvents, food oils, kerosine, paper, and wood. Particularly preferred among these organic materials are gases.

Flame may be diffusion flame or premixed flame. However, since diffusion flame is unstable and generates soot that can easily deteriorate the performance of the anode electrode layer, premixed flame is preferred. Premixed flame is stable and can be easily adjusted in its size. Further, premixed flame can be properly adjusted in fuel concentration to prevent the generation of soot.

Since the solid oxide fuel cell C is in a flat form, flame f from the burner 4 can be uniformly applied to the anode electrode layer 3 of the solid oxide fuel cell C, making it possible to apply flame f to the anode electrode layer without unevenness as compare with the tubular fuel cell. Further, by disposing the anode electrode layer 3 facing flame f, hydrocarbons, hydrogen, radicals (OH, CH, C₂, O₂H, CH₃) existing in the flame can be easily used as fuel for electricity generation based on oxidation-reduction reaction. Moreover, since the cathode electrode layer 2 is exposed to a gas containing oxygen such as air, oxygen can be easily used on the cathode electrode layer 2. Further, by blowing a gas containing oxygen onto the cathode electrode layer 2, the solid oxide fuel cell can be more efficiently rendered more oxygen-rich on the cathode electrode layer side thereof.

The electric power generated in the solid oxide fuel cell C is drawn out through lead wires L1, L2 extending from the cathode electrode layer 2 and the anode electrode layer 3, respectively. As each of the lead wires L1, L2 there is used one made of heat-resistant platinum or platinum alloy.

The solid oxide fuel cell C shown in FIG. 14 is in the form of a sheet of rectangular or circular flat plate. The electric power that can be drawn out of an electricity generation device including this one sheet of solid oxide fuel cell is limited. In order to enhance the output of the electricity generation device, an electricity generation device is proposed which includes a plurality of solid oxide fuel cells electrically connected to each other in combination (see, e.g., Patent Reference 2).

FIG. 15 depicts how a plurality of sheets of solid oxide fuel cell are incorporated in this electricity generation device. In this electricity generation device, the plurality of sheets of solid electrolyte substrate each form a solid oxide fuel cell. Thus, a fuel cell having no sealed structure is formed. In this arrangement, the shape of the fuel cell can be changed to different shapes. Further, the durability and electricity generation efficiency of the fuel cell can be enhanced.

In some detail, a plurality of sheet-like solid electrolyte substrate 1 are used. A cathode electrode layer 2 and an anode electrode layer 3 are formed on the respective side of each of these sheet-like solid electrolyte substrate 1 to form a plurality of solid oxide fuel cell C11 to C33. The cathode electrode layer of these fuel cells are electrically connected to each other with a wiring E1 and the anode electrode layer of these fuel cells are electrically connected to each other with a wiring E2. These anode electrode layers each are entirely exposed to flame produced by combustion of a fuel while air is supplied into these cathode electrode layers. By properly devising the electrical connection of the plurality of solid oxide fuel cell, the area of electricity generation can be increased to provide a solid oxide fuel cell having a raised output. The plurality of solid oxide fuel cell cannot be only disposed in plane but also in three-dimension such as cylinder and sphere.

[Patent Reference 1] JP-A-2004-139936

[Patent Reference 2] JP-A-2005-63692

The solid oxide fuel cells mentioned above each include a cathode electrode layer and an anode electrode layer formed on a sheet of flat solid electrolyte substrate. A step of producing such a solid oxide fuel cell is shown in FIG. 16. Firstly, a circular or rectangular sheet having a predetermined size allowing shrinkage which would be caused by sintering is formed by a green sheet made of a solid electrolyte material (Step S1). The green sheet having a predetermined size is then sintered (Step S2) to prepare an electrolyte substrate 1 for solid oxide fuel cell (Step S3).

Subsequently, a cathode electrode paste layer is formed on one side of the electrolyte substrate 1 by printing while an anode electrode paste layer is formed on the other side of the electrolyte substrate 1 by printing (Step S4). Thereafter, a metallic mesh is added to one or both of the cathode electrode paste layer and the anode electrode paste layer thus formed (Step S5). Further, a laminate of the electrolyte substrate 1, the cathode electrode paste layer, the anode electrode paste layer and the metallic mesh is formed. The laminate is then entirely fired (Step S6). Thus, a sheet of solid oxide fuel cell having a predetermined size including a cathode electrode layer 2 and an anode electrode layer 3 formed thereon is completed (Step S7).

The metallic mesh added to the cathode electrode paste layer and the anode electrode paste layer has an effect of retaining small pieces of fuel cell which would be produced even if the substrate is cracked by thermal shock applied to the solid oxide fuel cell during electricity generation. The fuel cell thus cracked remains capable of generating electricity. The metallic mesh acts to electrically connect small pieces of fuel cell. In this arrangement, electric power can be drawn out through lead wires L1 and L2. The metallic mesh also prevents the separation of fuel cell pieces produced by cracking to maintain the form of a sheet of solid oxide fuel cell.

In accordance with the procedure of producing a solid oxide fuel cell shown in FIG. 16, a green sheet made of an electrolyte material is sintered at high temperature to form a ceramic material in Step S2. During the sintering of the green sheet, the volume of the green sheet shrinks to cause cracking. The effect of shrinkage can cause the sintered substrate to be defected even if no cracking occurs. Accordingly, the electrolyte substrate is produced in a poor yield. In order to raise the yield, the preparation of the green sheet and the sintering of the green sheet require much trouble, adding to the manufacturing cost.

### SUMMARY OF THE INVENTION

It is therefore an aim of the invention to provide a solid oxide fuel cell which can be produced by a method which includes forming a plurality of small fuel cell divisions resistant to thermal shock to enhance thermal shock resistance during electricity generation and reduce the manufacturing cost of fuel cell and a method for manufacturing thereof.

In order to solve the aforementioned problems, there is provided a solid oxide fuel cell including: a laminate including a solid electrolyte substrate, a cathode electrode layer formed on a first side of the substrate and an anode electrode layer formed on a second side of the substrate, and an electrically-conductive material layer made of a plurality of conductors formed all over the solid electrolyte substrate on one or both of the cathode electrode layer side and the anode electrode layer side thereof, wherein the laminate includes a plurality of partial laminate divisions which are electrically connected to each other with the conductors.

Further, the electrically-conductive material layer is formed by a metallic mesh, and the partial laminate division has an irregular shape developed during the sintering thereof.

The electrically-conductive material layer extends from the laminate in at least one direction, or the electrically-conductive material layer on the cathode electrode layer side extends in directions different from directions on the anode electrode side of the laminate. Further, an insulating fixing material layer is formed on the peripheral edge the laminate.

Further, there is provided a method for manufacturing a solid oxide fuel cell including: a step of forming an electrolyte sheet having a predetermined shape by an electrolyte green sheet; a step of forming a cathode electrode paste layer on a first side of the electrolyte sheet and forming an anode electrode paste layer on a second side of the electrolyte sheet; a step of adding an electrically-conductive material layer made of a plurality of conductors to one or both of the cathode electrode paste layer and the anode electrode paste layer; and a step of sintering a laminate including the electrolyte sheet, the cathode electrode paste layer, the anode electrode paste layer and the electrically-conductive material layer.

Further, there is provided a method for manufacturing a solid oxide fuel cell including: a step of forming an electrolyte sheet having a predetermined shape by an electrolyte green sheet; a step of adding an electrically-conductive material layer made of a plurality of conductors to one or both sides of the electrolyte sheet; a step of forming a cathode electrode paste layer on a first side of the electrolyte sheet and forming an anode electrode paste layer on a second side of the electrolyte sheet, with the electrically-conductive material layer interposed therebetween; and a step of sintering a laminate including the electrolyte sheet, the cathode electrode paste layer, the anode electrode paste layer and the electrically-conductive material layer.

Further, there is provided a method for manufacturing a solid oxide fuel cell including: a step of forming an electrolyte sheet having a predetermined shape by an electrolyte green sheet; a step of providing an electrically-conductive material layer on a first and a second sides of the electrolyte sheet to interpose thereof; a step of forming a cathode electrode paste layer on a first side of the electrolyte sheet and forming an anode electrode paste layer on a second side of the electrolyte sheet, with the electrically-conductive material layer interposed therebetween; and a step of sintering a laminate including the electrolyte sheet, the cathode electrode paste layer, the anode electrode paste layer and the electrically-conductive material layer.

Further, there is provided a method for manufacturing a solid oxide fuel cell including: a step of forming a cathode electrode paste layer on an electrically-conductive material layer made of a plurality of conductors; a step of forming an anode electrode paste layer on the electrically-conductive material layer made of a plurality of conductors; a step of forming a solid electrolyte paste layer interposed between the cathode electrode paste layer and the anode electrode paste layer; and a step of sintering a laminate including the cathode electrode paste layer and the anode electrode paste layer containing the electrically-conductive material layer, and the solid electrolyte paste layer.

As mentioned above, the solid oxide fuel cell of the invention includes an electrically-conductive material layer made of a plurality of conductors formed all over a solid oxide substrate on one or both of the cathode electrode layer side thereof and the anode electrode layer side thereof, a laminate of a cathode electrode layer and a solid electrolyte substrate and an anode electrode layer including a plurality of partial laminate divisions wherein the plurality of partial laminate divisions are connected to each other with a conductor to form a plurality of small fuel cell portions. In this arrangement, at the step of producing the solid oxide fuel cell, the laminate can be divided into a plurality of small portions having a size large enough to undergo no effects of thermal shock during electricity generation to inhibit further occurrence of cracking, making it possible to enhance the thermal shock resistance of the solid oxide fuel cell.

The method for manufacturing a solid oxide fuel cell of the invention includes forming a cathode electrode paste layer and an anode electrode paste layer on one and the other sides of an electrolyte sheet having a predetermined shape, respectively, adding an electrically-conductive material layer made of a plurality of conductors to one or both of the cathode electrode paste layer and the anode electrode paste layer to form a laminate of an electrolyte sheet, a cathode electrode paste layer, an anode electrode paste layer and an electrically-conductive material layer and then sintering the laminate. In this manner, the step of sintering only the solid electrolyte substrate particularly as in the related art technique can be eliminated. Accordingly, even when the laminate is cracked and divided into a plurality of small fuel cell portions, the presence of the electrically-conductive material layer prevents the laminate from being completely separated from each other and thus allows the solid oxide fuel cell thus obtained to remain capable of generating electricity as it is. Thus, no strict quality control for enhancing yield in manufacturing is required.

Moreover, the job of forming the laminate of an electrolyte sheet, a cathode electrode paste layer, an anode electrode paste layer and an electrically-conductive material layer can be simplified to reduce the manufacturing cost. When sintered, the laminate undergoes cracking that causes division into a plurality of small fuel cell portions. The formation of the solid oxide fuel cell of the invention, however, is arranged such that small fuel cell portions having a size large enough to undergo no effects of thermal shock are formed to enhance the thermal shock resistance of the fuel cell during heating. Therefore, the occurrence of cracking during the sintering of the laminate is advantageous and can be made the effective use of to form a plurality of small fuel cell portions.

### BRIEF DESCRIPTION OF THE DRAWINGS

FIG. 1 is a diagram illustrating a first embodiment of the solid oxide fuel cell according to the invention.

FIG. 2 is a diagram illustrating a second embodiment of the solid oxide fuel cell according to the invention.

FIGS. 3A and 3B are diagrams illustrating a longitudinal section according to a specific example 1 of the solid oxide fuel cell of the second embodiment.

FIG. 4 is a diagram illustrating a longitudinal section according to a specific example 2 of the solid oxide fuel cell of the second embodiment.

FIG. 5 is a flow chart illustrating a manufacturing step example 1 of the solid oxide fuel cell according to the invention.

FIG. 6 is a flow chart illustrating a manufacturing step example 2 of the solid oxide fuel cell according to the invention.

FIG. 7 is a flow chart illustrating a manufacturing step example 3 of the solid oxide fuel cell according to the invention.

FIG. 8 is a flow chart illustrating a manufacturing step example 4 of the solid oxide fuel cell according to the invention.

FIGS. 9A and 9B are diagrams illustrating a third embodiment of the solid oxide fuel cell according to the invention.

FIGS. 10A and 10B are diagrams illustrating a modification example 1 of the third embodiment of the solid oxide fuel cell according to the invention.

FIG. 11 is a diagram illustrating a modification example 2 of the third embodiment of the solid oxide fuel cell according to the invention.

FIGS. 12A to 12C are diagrams illustrating a manufacturing step example of the solid oxide fuel cell according to the third embodiment.

FIG. 13 is a diagram illustrating an example of connection of the solid oxide fuel cell according to the invention.

FIG. 14 is a diagram illustrating a solid oxide fuel cell which allows direct utilization of flame to generate electricity.

FIG. 15 is a diagram illustrating an example of the formation of a large area fuel cell by electrical connection of a plurality of solid oxide fuel cells.

FIG. 16 is a flow chart illustrating a step of producing a solid oxide fuel cell according to the related art technique.

### DETAILED DESCRIPTION OF THE PREFERRED EMBODIMENTS

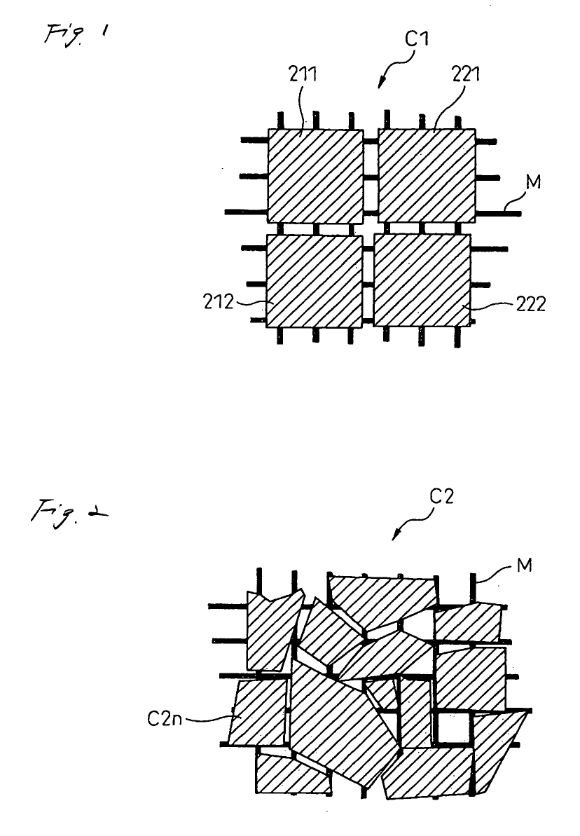

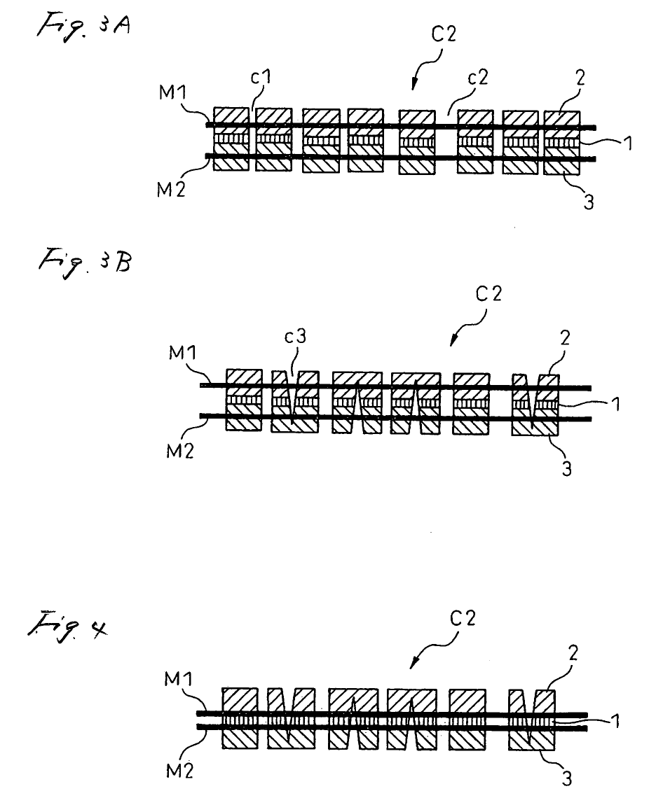

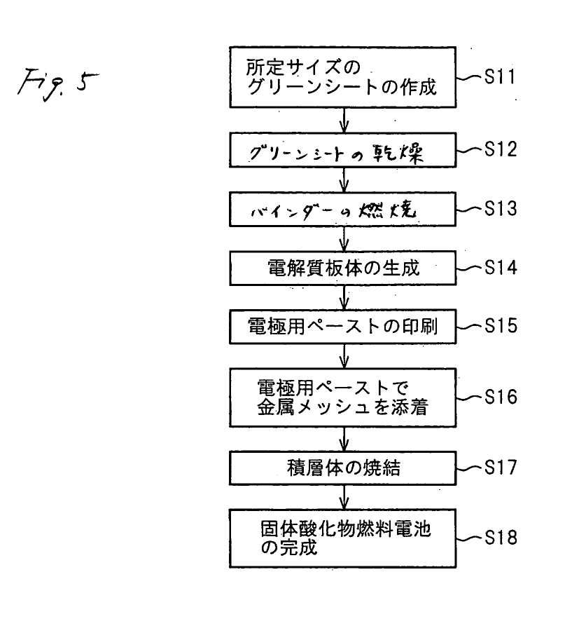

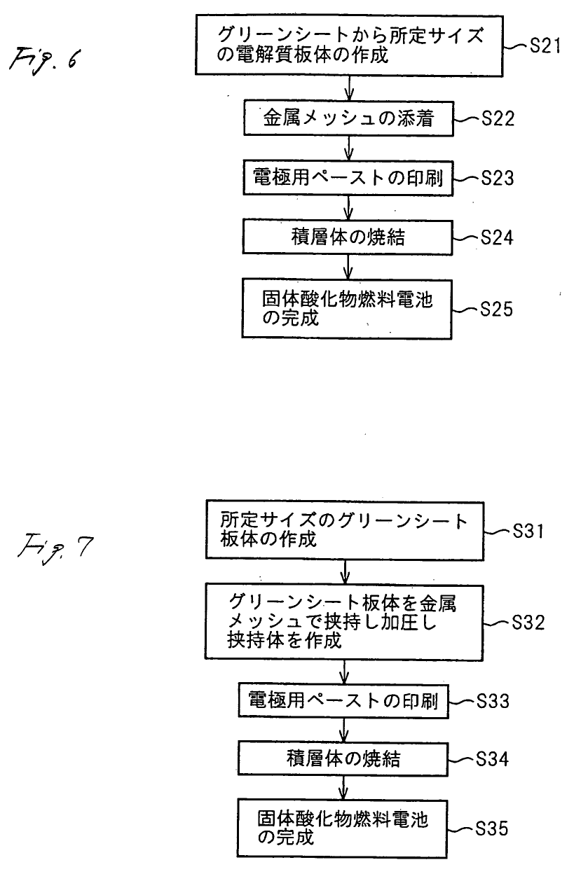

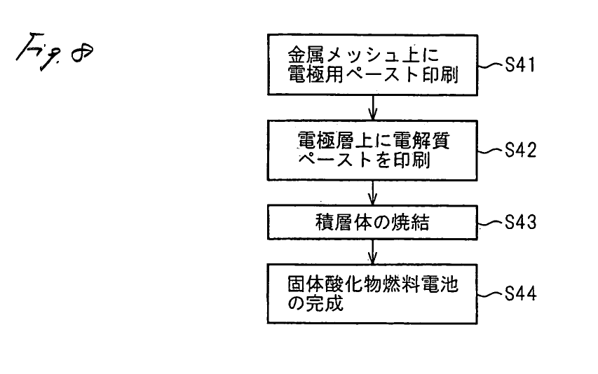

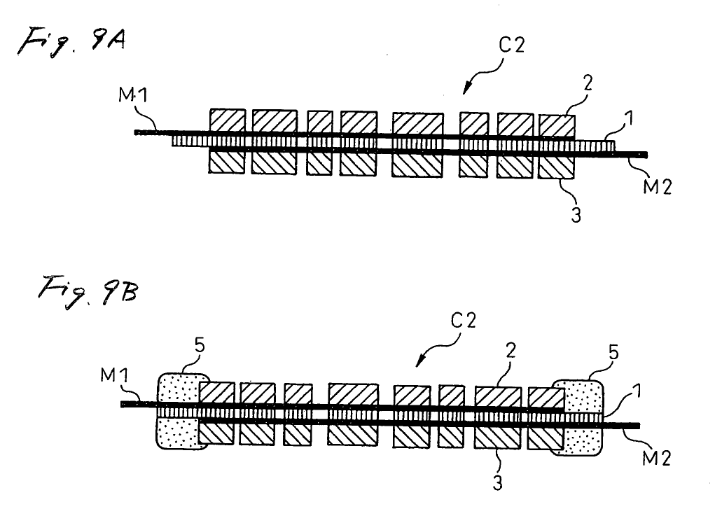

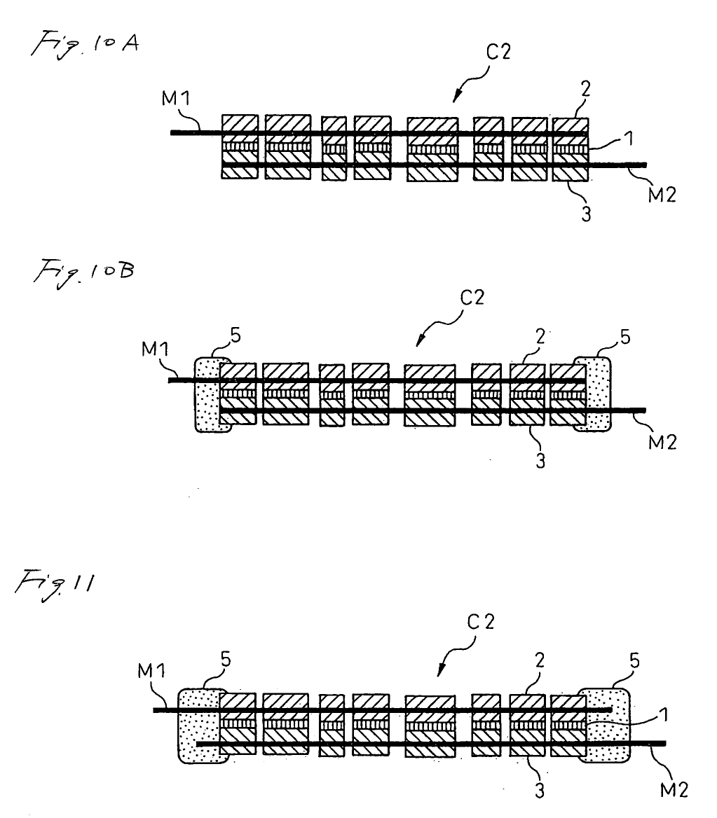

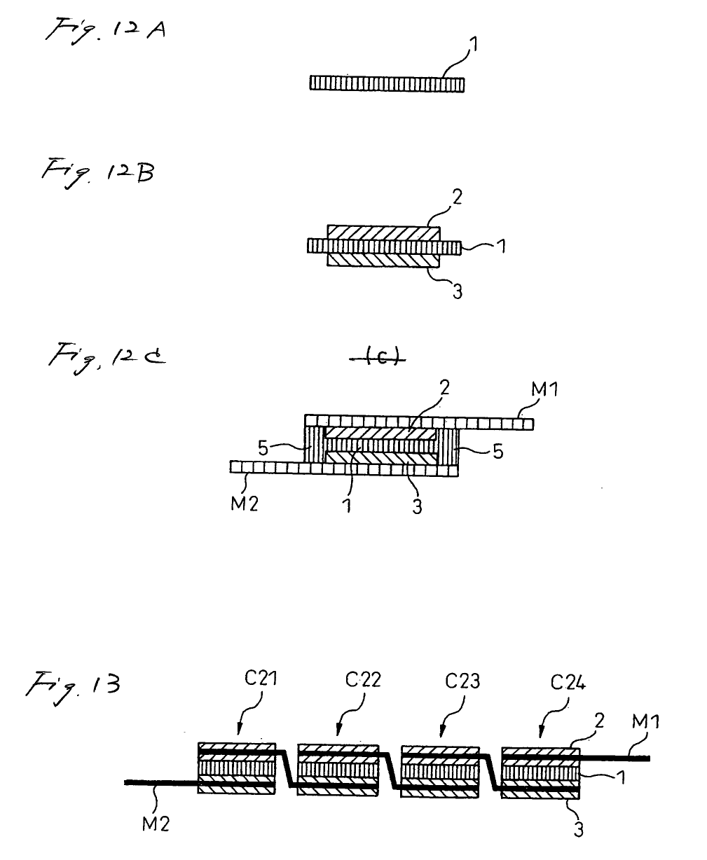

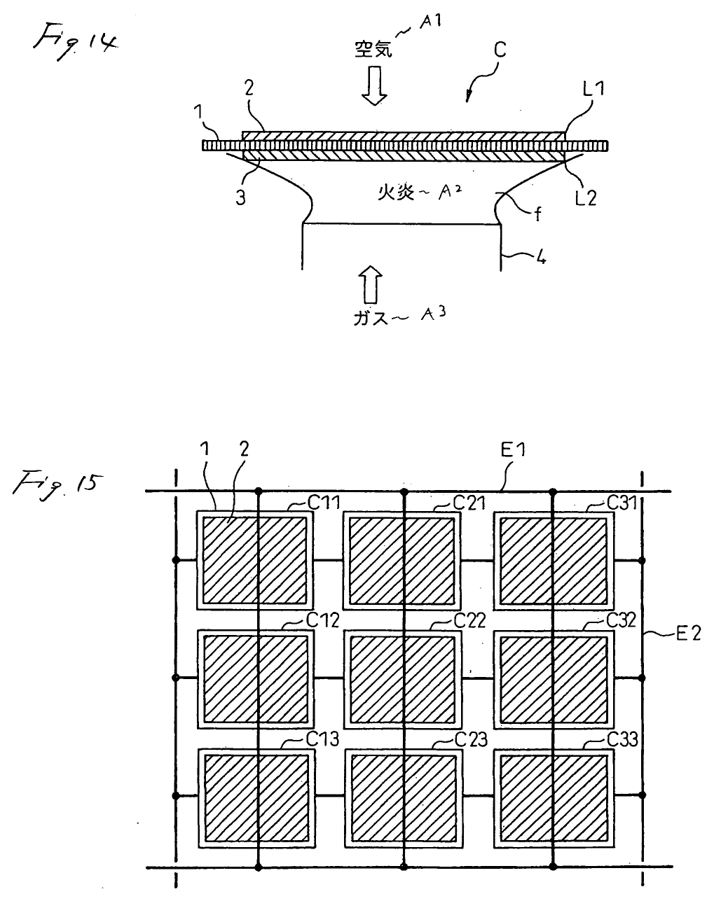

Embodiments of implementation of the solid oxide fuel cell of the invention will be described with reference to the configuration and manufacturing method of the solid oxide fuel cell in connection with FIGS. 1 to 13. The description of the configuration of the present embodiment of the solid oxide fuel cell will be preceded by the description of the electrolyte substrate material, the cathode electrode material and the anode electrode material which can be commonly used in solid oxide fuel cells.

As a solid electrolyte substrate 1 there may be used, e.g., any known material. Examples of such a material include the following materials.

a) YSZ (yttria-stabilized zirconia), ScSZ (scandia-stabilized zirconia), zirconia-based ceramics obtained by doping these materials with Ce, Al or the like

b) Ceria-based ceramics such as SDC (samaria-doped ceria) and GDC (gadolia-doped ceria)

c) LSGM (lanthanum gallate), bismuth oxide-based ceramics

As an anode electrode layer 3 there may be used, e.g., any known material. Examples of such a material include the following materials.

d) Cermets of nickel with yttria-stabilized zirconia-based, scandia-stabilized-based or ceria-based (e.g., SDC, GDC, YDC) ceramics

e) Sintered material mainly including an electrically-conductive oxide (50% to 99% by weight) (As the electrically-conductive oxide there may be used nickel oxide having lithium dissolved in solid state therein or the like)

f) Metal made of platinum element or oxide thereof incorporated in the materials d) and e) in an amount of from 1% to 10% by weight

Particularly preferred among these materials are materials d) and e).

Due to its excellent oxidation resistance, the sintered material mainly including the electrically-conductive oxide e) can prevent phenomena occurring due to the oxidation of the anode layer, e.g., drop of electricity generation efficiency or incapability of electricity generation due to the rise of the electrode resistivity of the anode layer and exfoliation of the anode layer from the solid electrolyte layer. As the electrically-conductive oxide there is preferably used nickel oxide having lithium dissolved therein in solid state. Further, the incorporation of a metal such as platinum group element or rhenium or oxide thereof in the materials d) and e) makes it possible to obtain a high electricity generation capability.

As the cathode electrode layer 2 there may be used any known material. Examples of such a material include manganate (e.g., lanthanum strontium manganite), gallate and cobaltate (e.g., lanthanum strontium cobaltate, samarium strontium cobaltate) of an element belonging to the group III such as lanthanum having strontium (Sr) incorporated therein.

The cathode electrode layer 2 and the anode electrode layer 3 each are formed by a porous material. The solid electrolyte substrate 1, too, can be in the form of porous material. As in the related art, the solid electrolyte substrate 1 may be in a dense form. However, a dense solid electrolyte substrate exhibits a low thermal shock resistance and thus can be easily cracked also by sudden temperature change. In general, the solid electrolyte substrate is formed thicker than the anode electrode layer and the cathode electrode layer. Accordingly, triggered by the cracking of the solid electrolyte substrate, the related art solid oxide fuel cell is entirely cracked. As a result, the solid oxide fuel cell is completely divided into pieces.

The porous solid electrolyte substrate thus formed cannot be cracked against sudden temperature change caused by flame ignition or extinction, even against heat cycle having a great temperature difference, during electricity generation, making it possible to enhance the thermal shock resistance of the solid oxide fuel cell. When the percent porosity of the solid electrolyte substrate, if porous, falls below 10%, the resulting solid oxide fuel cell is not observed to have remarkable enhancement of thermal shock resistance. When the percent porosity of the solid electrolyte substrate is 10% or more, the resulting solid oxide fuel cell is observed to have a good thermal shock resistance. When the percent porosity of the solid electrolyte substrate is 20% or more, the resulting solid oxide fuel cell is observed to have a better thermal shock resistance. This is presumably because when the solid electrolyte layer is porous, the thermal expansion caused by heating is relaxed by the void.

As shown in FIG. 16, the solid oxide fuel cell is produced by, e.g., the following method. Firstly, solid electrolyte material powders are mixed at a predetermined ratio. A flat green sheet is then formed by the powder mixture. Thereafter, the green sheet is sintered to prepare a solid electrolyte substrate. During this procedure, the kind and mixing ratio of material powders such as pore-forming material and the firing conditions such as firing temperature, firing time and prefiring condition can be properly adjusted to prepare solid electrolyte substrates having different percent porosities. An electrode paste constituting the cathode electrode layer is spread over one side of the solid electrolyte substrate, and then fired to produce a solid oxide fuel cell.

However, even the porous solid electrolyte substrate thus produced cannot be completely prevented from being cracked by thermal shock. In order to prevent this trouble, it is practiced as in the manufacturing step shown in FIG. 16 to add a metallic mesh to the entire surface of the cathode electrode layer and the anode electrode layer so that the fuel cell cannot be divided into pieces.

Focusing on the fact that even when the solid oxide fuel cell is cracked and divided into small portions by thermal shock, the small portions themselves remain capable of generating electricity as fuel cell as previously mentioned, the manufacturing of the solid oxide fuel cell is arranged such that the laminate is previously divided into a plurality of small portions having a size large enough to undergo no effects of thermal shock during electricity generation at the step of producing the solid oxide fuel cell.

A first embodiment of the solid oxide fuel cell according to the invention is shown in FIG. 1. FIG. 1 depicts a plan view of the solid oxide fuel cell as viewed from the cathode electrode layer 2 side thereof wherein a part of the solid oxide fuel cell is shown enlarged. In FIG. 1, a solid oxide fuel cell C1 is shown having four rectangular small fuel cell portions retained by a metallic mesh M. Under the cathode electrode layers 211 to 222 are formed a laminate of a solid electrolyte substrate 1 and an anode electrode layer 3 shaped in coincidence therewith.

Though depending on the gap between the conductors constituting the metallic mesh, when the four small fuel cell portions each have an area of 10 mm² or less for example, these small fuel cell portions can be difficultly cracked even against thermal shock occurring during the electricity generation by the solid oxide fuel cell. This is presumably because these small fuel cell portions allow uniform and rapid conduction of heat. The method for manufacturing the solid oxide fuel cell according to the first embodiment will be described later.

A second embodiment of the solid oxide fuel cell according to the invention is shown in FIG. 2. Similarly to FIG. 1, FIG. 2 depicts a plan view of the solid oxide fuel cell as viewed from the cathode electrode layer 2 side thereof wherein a part of the solid oxide fuel cell C2 is shown enlarged. While the rectangular small fuel cell portions are shown retained by the metallic mesh M in FIG. 1, a plurality of small fuel cell portions C2n having irregular shapes are shown retained by the metallic mesh M wherein the plurality of small fuel cell portions form the solid oxide fuel cell C2 in FIG. 2. The method for manufacturing the solid oxide fuel cell according to the second embodiment, too, will be described later.

A specific example 1 of the solid oxide fuel cell C2 including the plurality of irregularly shaped small fuel cell portions 2n shown in FIG. 2 is shown in FIG. 3 wherein a longitudinal section of the solid oxide fuel cell C2 is depicted. In the specific example 1 shown in FIG. 3, metallic meshes M1 and M2 are embedded in the cathode electrode layer 2 and the anode electrode layer 3, respectively. These metallic meshes are used as current collecting electrode as well.

While the metallic mesh M is shown embedded in both the cathode electrode layer 2 and the anode electrode layer 3 in FIG. 3, the metallic mesh M may be embedded in any one of the cathode electrode layer 2 and the anode electrode layer 3. In this arrangement, it is necessary that a current collecting electrode be provided on the side free of metallic mesh. While the cathode electrode layer 2 and the anode electrode layer 3 of the solid oxide fuel cell C2 each are shown thinner than the electrolyte substrate 1 for the convenience of explanation in FIG. 3, the electrolyte substrate 1 is actually formed thicker than the other layers.

The solid oxide fuel cell C2 shown in FIG. 3 makes the use of crack occurring during manufacturing the fuel cell to form irregularly shaped small fuel cell portions. Cracking occurs due to the difference in shrinkage between the electrolyte substrate 1, which shrinks during sintering, and the metallic meshes M1, M2, which don't. As a result, cracking occurs irregularly to form a plurality of irregularly shaped small fuel cell portions as shown in FIG. 3A. When these small portions are too small, they cannot be retained by the metallic meshes M1, M2 and thus fall off. As a result, the gaps between these small portions are irregular, giving gap spaces c1, c2 having different sizes as shown in FIGS. 2 and 3A.

While an example of the formation of a plurality of irregularly shaped small fuel cell portions is shown in FIG. 3A, cracking is described above occurring extending over both sides of the fuel cell as viewed on the section thereof. In actuality, however, cracking also extends to halfway along the section of the fuel cell as crack c3 shown in FIG. 3B. However, even when such crack as c3, too, occurs, the electricity generation capability of the small fuel cell portions cannot be affected.

The solid oxide fuel cell C2 shown in FIG. 3 is a specific example 1 of the solid oxide fuel cell having metallic meshes M1, M2 embedded in an electrode layer. FIG. 4 depicts a specific example 2 of the solid oxide fuel cell having metallic meshes M1, M2 laminated interposed between the electrolyte substrate and the electrode layer. FIG. 4 depicts the case where irregularly shaped small fuel cell portions containing cracks extending to halfway along the longitudinal section thereof are formed as in FIG. 3B.

The solid oxide fuel cell C2 according to the specific example 2 of FIG. 4 includes a metallic mesh M1 provided interposed between the electrolyte substrate 1 and the cathode electrode layer 2 and a metallic mesh M2 provided interposed between the electrolyte substrate 1 and the anode electrode layer 3. These metallic meshes are used as current collecting electrode as well.

As mentioned above, the solid oxide fuel cells according to the first and second embodiments shown in FIGS. 1 to 4 themselves each include a plurality of rectangular or irregularly shaped small fuel cell portions formed during manufacturing the fuel cell and thus can relax the occurrence of thermal shock due to heating during the electricity generation by the fuel cell and hence inhibit further occurrence of cracking.

As the metallic mesh to be used in the first and second embodiments there is used a lattice-like or networked high melting metal conductor layer which allows good conduction of heat by the heating of the solid oxide fuel cell and can act as current collecting electrode. In the case where a method metal is provided on the both sides of the electrolyte substrate, the electrically-conductive material layer is not necessarily lattice-like or networked but may be formed by rod-shaped conductors disposed juxtaposed. In this case, juxtaposed conductors disposed on the respective side of the electrolyte substrate can be arranged such that they extend in directions perpendicular to each other to fairly retain the plurality of small fuel cell portions.

The method for manufacturing the solid oxide fuel cell according to the present embodiment will be described in connection with flow charts shown in FIGS. 5 to 8. FIG. 5 depicts a step example 1 illustrating the procedure of producing the solid oxide fuel cells according to the first and second embodiments.

Firstly, a circular or rectangular sheet having a predetermined size allowing shrinkage which would be caused by sintering is formed by a green sheet obtained by kneading a solid electrolyte material with a binder (Step S11). The green sheet is then dried to a predetermined size (Step S12). The binder is then combusted (Step S13). Thus, an electrolyte sheet constituting the electrolyte substrate 1 of the solid oxide fuel cell is prepared (Step S14).

Subsequently, a cathode electrode paste layer and an anode electrode paste layer are formed on one and the other sides of the electrolyte sheet produced at Step S14 by printing, respectively (Step S15). Thereafter, a metallic mesh is bonded to one or both of the cathode electrode paste layer and the anode electrode paste layer with an electrode paste (Step S16).

Thus, a laminate of an electrolyte sheet, a cathode electrode paste layer, an anode electrode paste layer and a metallic mesh is formed. The laminate is then entirely sintered (Step S17). During the sintering of the laminate, the electrolyte sheet of the laminate shrinks while the metallic mesh doesn't. Accordingly, when the laminate is converted to a sintered ceramic material, the difference in shrinkage factor between the electrolyte sheet and the metallic mesh causes the laminate to be cracked and divided into a plurality of irregularly shaped small fuel cell portions. Thus, a solid oxide fuel cell having a predetermined size including a plurality of irregularly shaped small fuel cell divisions is completed (Step S18). In this manner, a solid oxide fuel cell according to the specific example 1 shown in FIGS. 2 and 3 is prepared.

While the present example of the step of producing a solid oxide fuel cell is described with reference to the case where irregularly shaped small fuel cell portions are formed, the manufacture of the solid oxide fuel cell according to the first embodiment shown in FIG. 1 may involve the formation of fine lattice-like notches on one or both sides of the electrolyte sheet produced at Step S14 in the flow chart of FIG. 5. In this manner, when the laminate is sintered at Step S17, no irregular cracks are formed, but cracking extends along the notches to form a plurality of small rectangular fuel cell portions.

FIG. 6 depicts a step example 2 illustrating the procedure of producing solid oxide fuel cells according to the first and second embodiments. Firstly, a circular or rectangular sheet having a predetermined size allowing shrinkage which would be caused by sintering is formed by a green sheet obtained by kneading a solid electrolyte material with a binder (Step S21). The binder is then combusted to form an electrolyte sheet. Thereafter, a metallic mesh is added to one or both sides of the electrolyte sheet (Step S22).

Subsequently, a cathode electrode paste layer and an anode electrode paste layer are formed on the metallic mesh formed at Step S22 on one and the other sides of the electrolyte sheet by printing, respectively (Step S23).

Thereafter, a laminate of an electrolyte, a cathode electrode paste layer, an anode electrode paste layer and a metallic mesh is formed. The laminated is then entirely sintered (Step S24). During the sintering of the laminate, the electrolyte sheet of the laminate shrinks while the metallic mesh doesn't. Accordingly, when the laminate is converted to a sintered ceramic material, the difference in shrinkage factor between the electrolyte sheet and the metallic mesh causes the laminate to be cracked and divided into a plurality of irregularly shaped small fuel cell portions. Thus, a solid oxide fuel cell having a predetermined size including a plurality of irregularly shaped small fuel cell divisions is completed (Step S25). In this manner, a solid oxide fuel cell according to the specific example 2 shown in FIG. 4 is prepared.

While the example 2 of the step of producing a solid oxide fuel cell is described with reference to the case where irregularly shaped small fuel cell portions are formed, the manufacture of the solid oxide fuel cell according to the first embodiment shown in FIG. 1 may involve the formation of fine lattice-like notches on one or both sides of the electrolyte sheet produced at Step S21 in the flow chart of FIG. 6. In this manner, when the laminate is sintered at Step S24, no irregular cracks are formed, but cracking extends along the notches to form a plurality of small rectangular fuel cell portions.

FIG. 7 depicts a step example 3 illustrating the procedure of producing solid oxide fuel cells according to the first and second embodiments. Firstly, a circular or rectangular sheet having a predetermined size allowing shrinkage which would be caused by sintering is formed by a green sheet obtained by kneading a solid electrolyte material with a binder (Step S31). The sheet is then pressed interposed between metallic meshes to form a clamped body (Step S32).

Subsequently, a cathode electrode paste layer and an anode electrode paste layer are formed on the metallic mesh formed at Step S32 on one and the other sides of the electrolyte sheet by printing, respectively (Step S33).

Thus, a laminate of an electrolyte, a cathode electrode paste layer, an anode electrode paste layer and a metallic mesh is formed. The laminated is then entirely sintered (Step S34). During the sintering of the laminate, the electrolyte sheet of the laminate shrinks while the metallic mesh doesn't. Accordingly, when the laminate is converted to a sintered ceramic material, the difference in shrinkage factor between the electrolyte sheet and the metallic mesh causes the laminate to be cracked and divided into a plurality of irregularly shaped small fuel cell portions. Thus, a solid oxide fuel cell having a predetermined size including a plurality of irregularly shaped small fuel cell divisions is completed (Step S35). In this manner, a solid oxide fuel cell according to the specific example 2 shown in FIG. 4 is prepared.

While the example 3 of the step of producing a solid oxide fuel cell is described with reference to the case where irregularly shaped small fuel cell portions are formed, the manufacture of the solid oxide fuel cell according to the first embodiment shown in FIG. 1 may involve the formation of fine lattice-like notches on one or both sides of the electrolyte sheet produced at Step S31 in the flow chart of FIG. 7. In this manner, when the laminate is sintered at Step S34, no irregular cracks are formed, but cracking extends along the notches to form a plurality of small rectangular fuel cell portions.

FIG. 8 depicts a step example 4 illustrating the procedure of producing a solid oxide fuel cell according to the second embodiment. Firstly, a cathode electrode paste is printed on a sheet of a metallic mesh to form a cathode electrode paste layer to a predetermined size. An anode electrode paste is printed on another sheet of a metallic mesh to form an anode electrode paste layer to a predetermined size (Step S41).

Subsequently, a solid electrolyte paste is printed on any one of the cathode electrode paste layer and the anode electrode paste layer formed at Step S41 to a predetermined size to form a solid electrolyte paste layer (Step S42). Subsequently, the other of the cathode electrode paste layer and the anode electrode paste layer is laminated on the solid electrolyte paste layer to form a laminate of a solid electrolyte paste, a cathode electrode paste layer, an anode electrode paste layer and a metallic mesh which is then entirely sintered (Step S43).

During the sintering of the laminate, the electrolyte paste layer of the laminate shrinks while the metallic mesh doesn't. Accordingly, when the laminate is converted to a sintered ceramic material, the difference in shrinkage factor between the electrolyte paste layer and the metallic mesh causes the laminate to be cracked and divided into a plurality of irregularly shaped small fuel cell portions. Thus, a solid oxide fuel cell having a predetermined size including a plurality of irregularly shaped small fuel cell divisions is completed (Step S44). In this manner, a solid oxide fuel cell according to the specific example 1 of the second embodiment shown in FIGS. 2 and 3 is prepared.

In accordance with the manufacturing methods according to the aforementioned manufacturing step examples, solid oxide fuel cells according to the first and second embodiments shown in FIGS. 1 and 2 are produced. The solid oxide fuel cells thus produced each have a plurality of small fuel cell portions connected to each other with a metallic mesh. In this arrangement, these solid oxide fuel cells each are in the form of a sheet of fuel cell but depend on the metallic mesh in its strength of shape. Accordingly, these solid oxide fuel cells are flexible and deflectable.

FIGS. 9 to 11 each depict a solid oxide fuel cell according to a third embodiment which provides reinforcement of the first and second embodiments and has a metallic mesh formed as a lead wire for drawing electric power. FIG. 9 a solid oxide fuel cell according to a third embodiment based on the specific example 2 shown in FIG. 4 by way of example.

The configuration shown in FIG. 9A is based on the configuration of the solid oxide fuel cell C2 according to the specific example 2 shown in FIG. 4. A solid oxide electrolyte substrate 1 is formed so large as to extend beyond the peripheral edge of a cathode electrode layer 2 and an anode electrode layer 3. Apart of the metallic mesh M1 on the cathode electrode layer 2 side extends beyond the solid electrolyte substrate 1. The metallic mesh M2 on the anode electrode layer 3 side extends from the solid electrolyte substrate 1 in a direction which is at least different from the direction of extension of the metal mesh M1, e.g., in the direction opposite the direction of extension of the metallic mesh M1 in the case of FIG. 9A.

Further, as shown in FIG. 9B, the part of the solid electrolyte substrate 1 extending beyond the peripheral edge of the solid oxide fuel cell C2 is covered by an insulating inorganic material. For example, a fixing member layer 5 of an electrolyte material is formed all over the periphery of the solid electrolyte substrate 1 to a predetermined thickness. The fixing member layer 5 acts as a frame body for the fuel cell to inhibit the deflection of the solid oxide fuel cell C2. In this arrangement, the metallic meshes M1 and M2, which extend beyond the fixing member layer 5, each act as a lead wire for drawing electric power. While the third embodiment is described with reference to the specific example 2 by way of example, this application can be made also to the solid oxide fuel cell C2 according to the specific example 1.

FIG. 10 depicts an example 1 of modification of the solid oxide fuel cell according to the third embodiment based on the specific example 1 shown in FIG. 3. While the solid oxide fuel cell of FIG. 9 is based on the third embodiment including the specific example 2 shown in FIG. 4 by way of example, the modification example 1 of FIG. 10 employs the configuration of the solid oxide fuel cell C2 based on the specific example 1 shown in FIG. 3 as shown in FIG. 10A. In some detail, a part of the metallic mesh M1 on the cathode electrode layer 2 side extends beyond the solid electrolyte substrate 1 and the metallic mesh M2 on the anode electrode layer 3 side extends from the solid electrolyte substrate 1 in a direction which is at least different from the direction of extension of the metal mesh M1, e.g., in the direction opposite the direction of extension of the metallic mesh M1 in the case of 10A.

Further, as shown in FIG. 10B, the peripheral of the solid electrolyte substrate 1 extending beyond the peripheral edge of the solid oxide fuel cell C2 is covered by an insulating inorganic material. For example, a fixing member layer 5 of an electrolyte material is formed all over the periphery of the solid electrolyte substrate 1 to a predetermined thickness. The fixing member layer 5 acts as a frame body for the fuel cell to inhibit the deflection of the solid oxide fuel cell C2. In this arrangement, the metallic meshes M1 and M2, which extend beyond the fixing member layer 5, each act as a lead wire for drawing electric power.

FIG. 11 depicts an example 2 of modification of the solid oxide fuel cell according to the third embodiment. In the case of the modification example 1 of FIG. 10, a part of the metallic mesh M1 on the cathode electrode layer side 2 extends beyond the solid electrolyte substrate 1 and the metallic mesh M2 on the anode electrode layer side 3 merely extends beyond the solid electrolyte substrate 1 in the direction opposite the direction of extension of the metallic mesh M1 as shown in FIG. 10A. In the modification example 2 shown in FIG. 11, the metallic meshes M1 and M2 are formed so large as to extend beyond the solid electrolyte substrate 1 all over the periphery of the solid oxide fuel cell C2.

The peripheral edge of the solid oxide fuel cell C2 is covered by an insulating inorganic material. For example, a fixing member layer 5 of an electrolyte material is formed all over the periphery of the solid electrolyte substrate 1 to a predetermined thickness. The fixing member layer 5 acts as a frame body for the fuel cell to which the entire periphery of the metallic meshes M1 and M2 are fixed. In this arrangement, the deflection of the solid oxide fuel cell C2 can be inhibited more than in the modification example 1 shown in FIG. 10. The metallic meshes M1 and M2, which extend beyond the fixing member layer 5, each act as a lead wire for drawing electric power.

The procedure of manufacturing the solid oxide fuel cell C2 according to the modification example 2 of the third embodiment shown in FIG. 11 is schematically shown in FIG. 12. As shown in FIG. 12A, an electrolyte green sheet constituting the solid electrolyte substrate 1 is prepared. As shown in FIG. 12B, a cathode electrode paste layer 2 is formed on one side of the electrolyte green sheet while an anode electrode paste layer 3 is formed on the other side of the electrolyte green sheet.

Subsequently, as shown in FIG. 12C, a fixing member layer 5 of an electrolyte material is formed on the peripheral edge of the electrolyte green sheet 1. Thereafter, a metallic mesh M1 is contact-bonded to the cathode electrode paste layer 2 and the fixing member layer 5 and a metallic mesh M2 is contact-bonded to the anode electrode paste layer 3 and the fixing member layer 5 to form a laminate. The laminate is then sintered to a ceramic material. Thus, a solid oxide fuel cell C2 is completed. During the sintering of the laminate, the electrolyte green sheet shrinks to form a plurality of irregularly shaped small fuel cell portions.

The foregoing description is made with reference to the configuration of a sheet of solid oxide fuel cell and its manufacturing method. The use of a plurality of sheets of the solid oxide fuel cell in combination is shown in FIG. 13. As one of the plurality of solid oxide fuel cells there may be used the configuration of the solid oxide fuel cells according to the first to third embodiments. This solid oxide fuel cell has metallic meshes M1, M2 extending outside the fuel cell as lead wire. Therefore, the connection of these solid oxide fuel cells to each other is made with the extending part of the metallic meshes M1, M2.

In FIG. 13, four sheets of solid oxide fuel cell C21 to C24 are connected in series with each other with the metallic meshes M1, M2. When the metallic meshes M1, M2 in each of these solid oxide fuel cells extend in the opposing directions, this arrangement is advantageous in the series connection of a plurality of solid oxide fuel cells. When the metallic meshes M1, M2 in each of these solid oxide fuel cells extend in both directions, a plurality of solid oxide fuel cells can be connected in parallel to each other. In the case where a plurality of solid oxide fuel cells are connected to each other in parallel to each other, the plurality of solid oxide fuel cells can be simultaneously formed apart from each other on the metallic meshes M1, M2 having a large area.

Embodiments 1 and 2 of the solid oxide fuel cell having a plurality of irregularly shaped small fuel cell portions which is described will be described hereinafter.

### Embodiment 1

In Embodiment 1, a paste made of a mixture of 50 wt-% of samarium strontium cobaltite (SSC) and 50 wt-% of samarium-doped ceria (Ce_{0.8}Sm_{0.2}O_{1.9}, SDC) is printed on a #80 (Japanese Industrial Standards) platinum mesh having a size of about 6 mm×15 mm in an area of about 6 mm×6 mm at one end thereof, and then dried. An SDC paste is printed on the paste layer in a slightly larger area, and then dried.

A paste made of a 15:45:40 (by weight) mixture of NiO—CoO—SDC is printed on another platinum mesh having the same shape as mentioned above, and then dried. The same paste is further spread over the SDC paste layer. The SDC paste layer of the platinum mesh on which the SSC paste layer is formed is laminated on the SDC paste layer, and then dried to form an integrated body. Subsequently, the integrated body is calcined at 1,200° C. in the atmosphere for 2 hours.

The solid oxide fuel cell thus obtained by calcining is observed having a number of fine irregular cracks running to form irregularly shaped and sized island-shaped small fuel cell divisions. However, these small fuel cell divisions are observed firmly connected to each other with the platinum mesh. In order to evaluate the solid oxide fuel cell for electricity generation capability as a fuel cell, the surface of the anode electrode layer of the solid oxide fuel cell is directly exposed to premixed flame of n-butane. As a result, the open circuit voltage is about 0.5 V and the short-circuit current is about 200 mA.

### Embodiment 2

In Embodiment 2, a mixture of SDC powder, polyvinyl butyral and dibutyl phthalate is slurried by a ball mill method. A green sheet having a thickness of about 0.2 mm is then prepared from the slurry. A paste made of a mixture of 50 wt-% of SSC and 50 wt-% of SDC is printed on one side of the green sheet while a paste made of a 15:45:40 (by weight) mixture of NiO—CoO—SDC is printed on the other side of the green sheet. The coated green sheet is then dried. The green sheet thus dried is then stamped to a disc having a diameter of about 20 mm.

Subsequently, two sheets of #80 platinum mesh having a diameter of about 20 mm obtained by stamping are welded to a platinum wire. The two sheets of platinum mesh are then pressed between flat metallic plates with the disc of green sheet prepared above interposed therebetween to form an integrated body. The aforementioned SSC-SDC mixture paste is printed on the SSC-SDC printed side of the integrated disc, and then dried. The aforementioned NiO—CoO—SDC mixture paste is spread over the other side of the disc thus dried, and then dried. The disc is then calcined at 1,200° C. in the atmosphere for 2 hours.

The solid oxide fuel cell thus obtained by calcining is observed having a number of fine irregular cracks running to form irregularly shaped and sized island-shaped small fuel cell divisions. However, these small fuel cell divisions are observed firmly connected to each other with the platinum mesh. The surface of the anode electrode layer of the solid oxide fuel cell is directly exposed to premixed flame of n-butane. As a result, the open circuit voltage is about 0.5 V and the short-circuit current is about 200 mA.

[FIG. 5]

S11: Prepare green sheet having a predetermined size

S12: Dry green sheet

S13: Combust binder

S14: Prepare electrolyte sheet

S15: Print electrode paste

S16: Add metallic mesh with electrode paste

S17: Sinter laminate

S18: Complete solid oxide fuel cell

[FIG. 6]

S21: Prepare electrolyte sheet having a predetermined size from green sheet

S22: Add metallic mesh

S23: Print electrode paste

S24: Sinter laminate

S25: Complete solid oxide fuel cell

[FIG. 7]

S31: Prepare green sheet having a predetermined size

S32: Press green sheet interposed between metallic meshes to prepare clamped body

S33: print electrode paste

S34: Sinter laminate

S35: Complete solid oxide fuel cell

[FIG. 8]

S41: Print electrode paste on metallic mesh

S42: Print electrolyte paste on electrode layer

S43: Sinter laminate

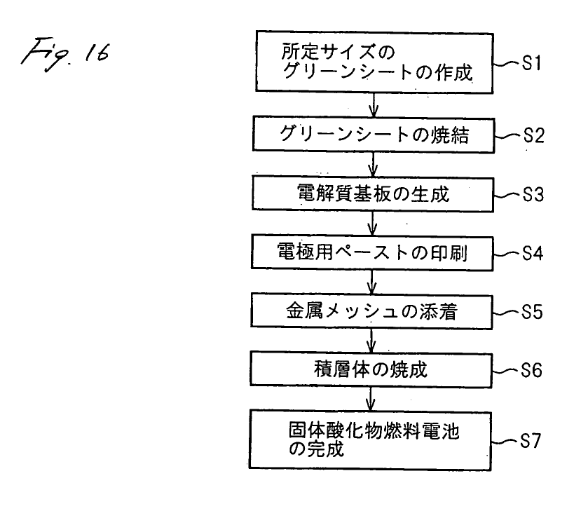

S44: Complete solid oxide fuel cell

[FIG. 14]

A1: Air

A2: Flame

A3: Gas

[FIG. 16]

S1: Prepare green sheet having a predetermined size

S2: Sinter green sheet

S3: Prepare electrolyte substrate

S4: Print electrode paste

S5: Add metallic mesh

S6: Fire laminate

S7: Complete solid oxide fuel cell

What is claimed is:

1. A solid oxide fuel cell comprising:
a laminate including a solid electrolyte substrate, a cathode electrode layer formed on a first side of the substrate and an anode electrode layer formed on a second side of the substrate, and
an electrically-conductive material layer made of a plurality of conductors formed all over the solid electrolyte substrate on one or both of the cathode electrode layer side and the anode electrode layer side thereof, wherein
the laminate includes a plurality of partial laminate divisions which are electrically connected to each other with the conductors.

2. The solid oxide fuel cell as defined in claim 1, wherein
the electrically-conductive material layer is formed by a metallic mesh.

3. The solid oxide fuel cell as defined in claim 1, wherein
the partial laminate division has an irregular shape developed during the sintering thereof.

4. The solid oxide fuel cell as defined in claim 1, wherein
the electrically-conductive material layer extends from the laminate in at least one direction.

5. The solid oxide fuel cell as defined in claim 4, wherein
the electrically-conductive material layer on the cathode electrode layer side extends in directions different from directions on the anode electrode layer side.

6. The solid oxide fuel cell as defined in claim 1, further comprising:
an insulating fixing material layer formed on the peripheral edge of the laminate.

7. A method for manufacturing a solid oxide fuel cell comprising:
a step of forming an electrolyte sheet having a predetermined shape by an electrolyte green sheet;
a step of forming a cathode electrode paste layer on a first side of the electrolyte sheet and forming an anode electrode paste layer on a second side of the electrolyte sheet;
a step of adding an electrically-conductive material layer made of a plurality of conductors to one or both of the cathode electrode paste layer and the anode electrode paste layer; and
a step of sintering a laminate including the electrolyte sheet, the cathode electrode paste layer, the anode electrode paste layer and the electrically-conductive material layer.

8. A method for manufacturing a solid oxide fuel cell comprising:
a step of forming an electrolyte sheet having a predetermined shape by an electrolyte green sheet;
a step of adding an electrically-conductive material layer made of a plurality of conductors to one or both sides of the electrolyte sheet;
a step of forming a cathode electrode paste layer on a first side of the electrolyte sheet and forming an anode electrode paste layer on a second side of the electrolyte sheet, with the electrically-conductive material layer interposed therebetween; and
a step of sintering a laminate including the electrolyte sheet, the cathode electrode paste layer, the anode electrode paste layer and the electrically conductive material layer.

9. A method for manufacturing a solid oxide fuel cell comprising:
a step of forming an electrolyte sheet having a predetermined shape by an electrolyte green sheet;
a step of providing an electrically-conductive material layer on a first and a second sides of the electrolyte sheet to interpose thereof;
a step of forming a cathode electrode paste layer on a first side of the electrolyte sheet and forming an anode electrode paste layer on a second side of the electrolyte sheet, with the electrically-conductive material layer interposed therebetween; and
a step of sintering a laminate including the electrolyte sheet, the cathode electrode paste layer, the anode electrode paste layer and the electrically-conductive material layer.

10. A method for manufacturing a solid oxide fuel cell comprising:
a step of forming a cathode electrode paste layer on an electrically-conductive material layer made of a plurality of conductors;
a step of forming an anode electrode paste layer on the electrically-conductive material layer made of a plurality of conductors;
a step of forming a solid electrolyte paste layer interposed between the cathode electrode paste layer and the anode electrode paste layer; and
a step of sintering a laminate including the cathode electrode paste layer and the anode electrode paste layer containing the electrically-conductive material layer, and the solid electrolyte paste layer.

11. The solid oxide fuel cell as defined in claim 1, wherein
the percent porosity of the solid electrolyte substrate is 10% or more.

12. The manufacturing method as defined in claim 7, wherein
the percent porosity of the solid electrolyte substrate is 10% or more.

13. The manufacturing method as defined in claim 8, wherein
the percent porosity of the solid electrolyte substrate is 10% or more.

14. The manufacturing method as defined in claim 9, wherein
the percent porosity of the solid electrolyte substrate is 10% or more.

15. The manufacturing method as defined in claim 10, wherein
the percent porosity of the solid electrolyte substrate is 10% or more.
